(19) United States
(12) Patent Application Publication
(10) Pub. No.: US 2011/0209888 A1
(43) Pub. Date: Sep. 1, 2011

(54) HAND-HELD OSCILLATORY POWER TOOL WITH TWO-AXIS TOOL MOUNTING

(75) Inventor: Christopher Thomas Elsworthy, Bristol (GB)

(73) Assignee: C ENTERPRISE (HK) LIMITED, Kowloon Bay (HK)

(21) Appl. No.: 12/714,466

(22) Filed: Feb. 27, 2010

(51) Int. Cl. B25F 5/00; B25F 5/02; B23B 31/107

(52) U.S. Cl. 173/217; 173/170; 173/171; 279/82

(57) ABSTRACT

A hand-held power tool includes a motor mounted in a housing, with a two-axis universal joint mounted to the housing and supporting a rotary chuck. The universal joint includes a yoke mounted to the housing and a hub mounted to the yoke, the hub supporting the chuck. First and second clutches are provided for locking the yoke and the hub. A locking mechanism operatively connects the first and second clutches, and releases both of the first and second clutches simultaneously. A quick release chuck includes a spindle having a longitudinal bore for accepting a shank. A ball or like engaging device is disposed in a radial bore, extending into the longitudinal bore, and radially movable so that at least a portion of the ball extends radially into the longitudinal bore to engage a recess in the shank. A spring biased outer collar disposed about the spindle is movable longitudinally relative to the spindle and has a tapered face for forcing the ball into an aperture. A spring biases the collar into a locking position.

### TECHNICAL FIELD

The present invention relates to hand-held power tools, particularly multi-purpose power tools.

### BACKGROUND OF THE INVENTION

Various hand-held oscillatory power tools are useful for performing cutting operations, such as sawing, sanding, grinding, and polishing. Particularly for fine work, and when the tool is being used for an extended time, physical stresses can result and the ergonomic features of the tool are very important. It will be understood that there is a need for a power tool which reduces the physical stress that can occur using prior art tools.

Various quick release chucks are known in the art for holding tools or bits. Many prior designs proved to be either too complicated to mass produce on a commercial basis, or simply did not provide satisfactory performance. Accordingly, an uncomplicated and easy to produce quick release chuck which affords quick and easy change-out of saw blades without degrading the reliability or safety of the tool would be an extremely beneficial and welcome advancement in the art.

### DISCLOSURE OF THE INVENTION

According to one aspect of the present invention there is provided a hand-held power tool; comprising:

a housing;

a motor mounted in the housing;

a two-axis universal joint mounted to the housing, the universal joint supporting a rotary chuck; and

a drive connected between the motor and the chuck, for transmitting torque to the chuck.

Preferably the drive is an oscillatory drive for transmitting an oscillating torque to the chuck.

Preferably the universal joint includes:

a yoke mounted to the housing to pivot relative to the housing about a first axis;

a hub supporting the chuck for rotation about a chuck axis, and

a pivot defining a second axis substantially perpendicular to the first axis, the pivot connecting the yoke and hub, whereby the chuck and hub may be pivoted together relative to the yoke about the second axis;

first and second clutches for locking the yoke and hub against turning relative to the housing and yoke respectively;

a locking mechanism operatively connecting the first and second clutches, and

an actuator that is manually operated to actuate the locking mechanism to release both the first and second clutches simultaneously.

Preferably the clutches are positive or dog type clutches.

Preferably the motor is a rotary motor mounted to rotate with the yoke. Preferably the yoke includes a cavity in which the rotary motor is received.

Preferably the rotary motor has a drive shaft which rotates about the first axis and the oscillatory drive includes an eccentric coupled to the drive shaft. Preferably the chuck axis of the chuck is aligned substantially perpendicular to the second axis, and the oscillatory drive includes a fork that engages the eccentric, the fork being rotationally fast with the chuck.

Preferably the locking mechanism includes a slider rotating together with the yoke about the first axis, the slider being mounted for sliding movement relative to the yoke, the slider being operatively connected to the actuator such that operation of the actuator displaces the slider along the first axis;

the first clutch includes a first pair of tooth sets,

the second clutch includes a second and a third pair of tooth sets, and

a coupling mechanism that, during movement of the slider along the first axis to a locking position, displaces one tooth set of the first pair to engage the other tooth set of the first pair, and that simultaneously urges the tooth sets of the second and third pairs together.

Preferably the locking mechanism further includes a rotary cam operatively coupled to the actuator and a biasing spring urging the slider to engage the cam, the cam acting upon the slider to move the slider along the first axis against the biasing spring.

Preferably the slider includes two arms elongated generally in the direction of the first axis and disposed on opposing sides of the yoke, both of the arms acting to displace the one of the tooth sets of the first pair, and wherein the coupling mechanism includes a wedge fixed to each arm, one of the wedges engaging the one tooth set of the second pair and the other of the wedges engaging the one tooth set of the third pair.

Preferably no hand grip, or trigger adapted to be operated by a used holding the hand grip, is provided on the housing. Preferably the power tool further includes a handle module detachably mountable to the housing, the handle module including a hand grip, a trigger and a battery pack.

Optionally the power tool may further include a tool- or work-supporting device for supporting the toll or workpiece during operation. A tool- or work-supporting device may include a base plate, a workbench or a sliding tool mount to which the housing may be fixed.

In another aspect the invention provides a quick release chuck for releasably engaging a shank, the chuck comprising:

a spindle having an internal longitudinal bore defined therein for accepting a shank inserted into the bore;

at least one radial bore defined in the spindle and extending into the longitudinal bore;

an engaging device disposed in the radial bore, the engaging device being radially movable within the radial bore so that at least a portion of the engaging device extends radially into the longitudinal bore in a locking mode of the chuck;

a spring biased outer collar disposed about at least a portion of the spindle, the outer collar movable longitudinally relative to the spindle between a released position and a locking position, the outer collar comprising an engaging surface having a portion contacting the engaging member and forcing the engaging member radially inward in the locking position to engage with a recess defined in the shank inserted into the longitudinal bore, the engaging surface allowing the engaging member to move radially outward in the released position to release a saw blade from the chuck device; and

a spring member operably disposed relative to the outer collar and the spindle to bias the collar to the locking position.

Preferably the chuck further comprising a mating mechanism for mating the spindle to a driving member of a power tool.

Preferably the mating mechanism comprises an array of pins.

Preferably the spindle is rotationally fast with a driving member of a power tool.

Preferably the at least one radial bore comprises two radially oppositely disposed radial bores and engaging members such that the engaging members engage with opposite sides of the shank into the longitudinal bore.

Preferably the engaging member comprises a ball.

Preferably the engaging surface further comprises a tapered section contacting the engaging mechanism in the locking position and an adjacent section which defines a recess area for the detente ball in the released position of the outer collar.

Preferably the chuck further comprises a pair plungers for abutting opposing sides of the collar, a cam for abutting each of the plungers, and a lever connecting both cams for displacing the plungers simultaneously to release the shank.

This invention provides a power tool which can be effectively and efficiently used with the axis of rotation of the chuck oriented at different angles to the housing, allowing an ergonomically optimum gripping position to be maintained by the user, independently of the required orientation of the chuck. Also provided by the invention is a quick release chuck which is uncomplicated and easy to produce, and which affords quick and easy change-out of saw blades without degrading the reliability or safety of the tool.

### BRIEF DESCRIPTION OF THE DRAWINGS

Preferred forms of the present invention will now be described by way of example with reference to the accompanying drawings, wherein:

FIG. 1 is a side view of an exemplary power tool according to the invention;

FIGS. 2a-2c are perspective views of the power tool of FIG. 1 in three different operating positions;

FIG. 3 is an oblique view of a section along plane AA of FIG. 1;

FIG. 4 is a schematic illustration of the universal joint locking mechanism of the tool of FIG. 1;

FIG. 5 is a perspective view showing the slider of the universal joint locking mechanism of FIG. 4;

FIG. 6 is a schematic longitudinal section through part of a first clutch of the universal joint locking mechanism of FIG. 4;

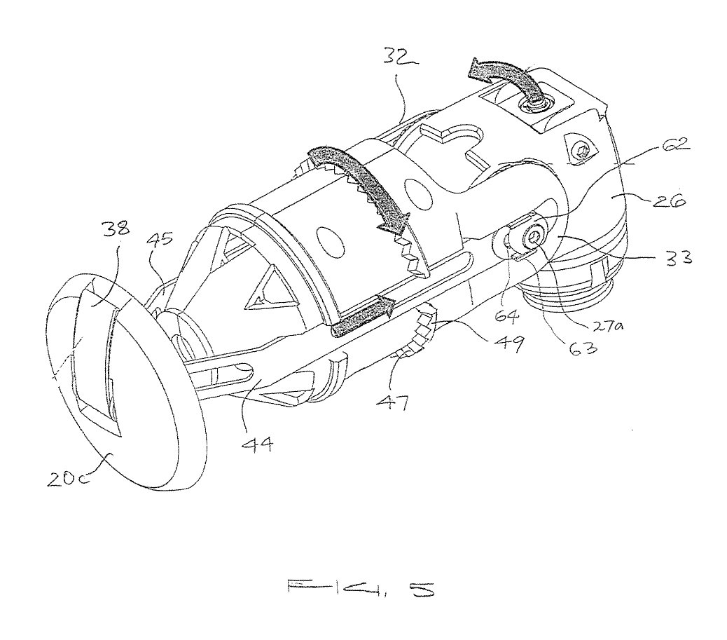

FIG. 7 is a schematic longitudinal section through part of a second clutch of the universal joint locking mechanism of FIG. 4;

FIG. 8 is a schematic section along plane BB of FIG. 1, and

FIG. 9 is a schematic section through the hub of the universal joint in a plane perpendicular to the section of FIG. 8.

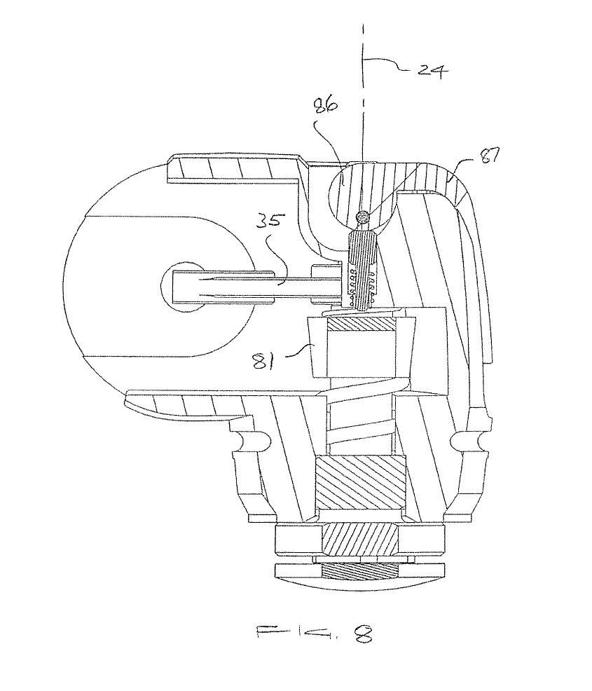

### DESCRIPTION OF THE PREFERRED EMBODIMENTS

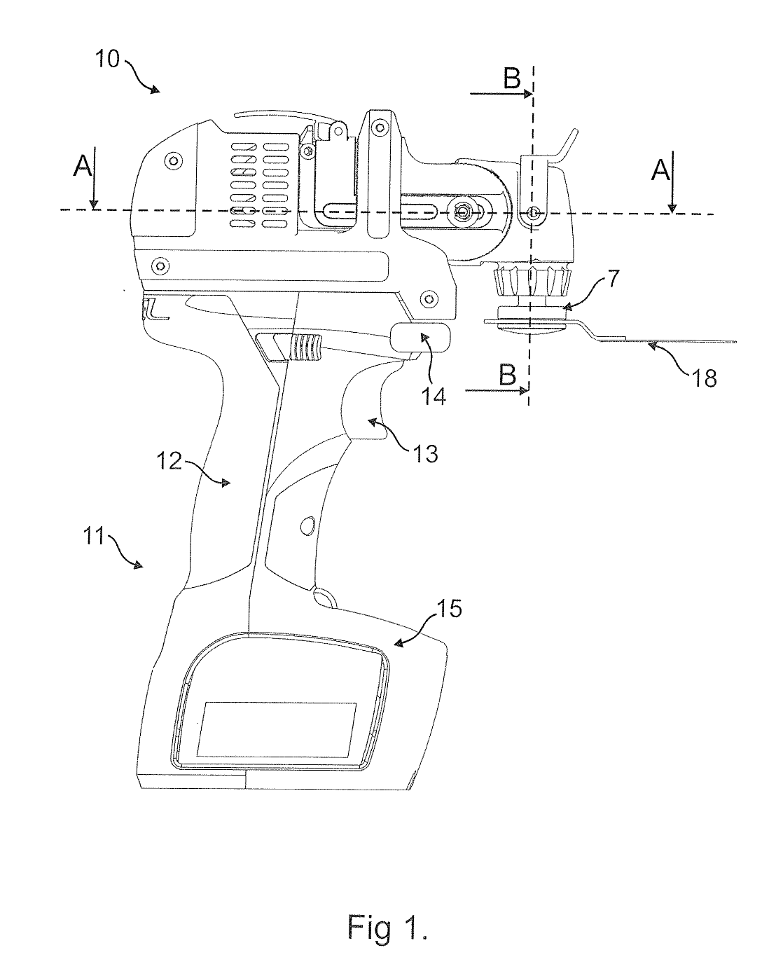

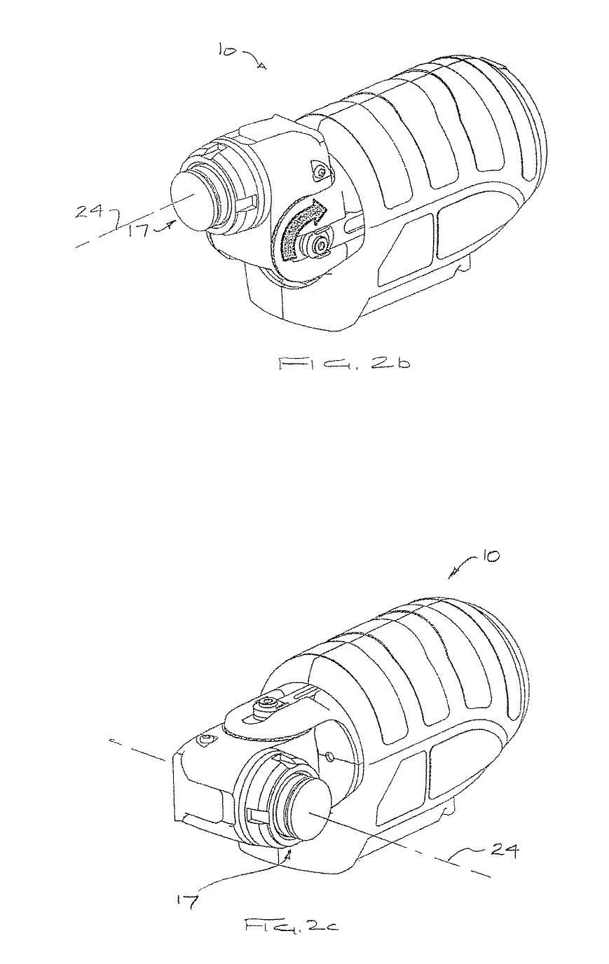

Referring to FIG. 1 a hand tool according to an embodiment of the invention includes a modular tool body 10 and a handle assembly 11, from which the tool body 10 can be demounted. The handle assembly 11 includes a hand-grip portion 12, a trigger 13, a control button 14 and a battery pack portion 15. Electrical contact pairs (not shown) at the interface between the tool body 10 and handle assembly 11 are mutually engaged when the two parts are connected, as shown in FIG. 1, allowing power to be supplied from batteries (not shown) in the battery pack portion 15 to a rotary electric motor 16 (FIG. 3) disposed in the tool body 10. The motor 15 powers an oscillatory drive, described in more detail below, to oscillate a chuck 17 and an attached tool 18. The tool 18 shown is a blade but many alternative coarse or fine cutting tools, such as sanding, grinding, polishing tools, or the like, may be held in the chuck 17

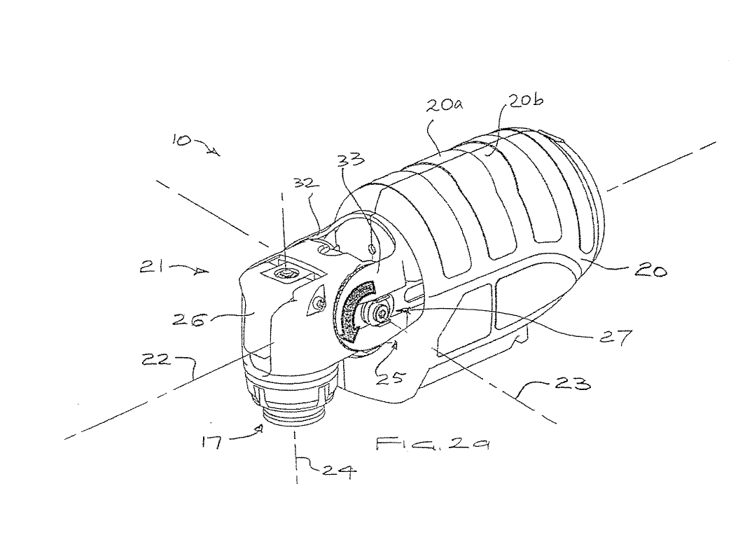

FIGS. 2a-2c show that the tool body 10 comprises a housing 20 to which the chuck 17 is mounted by a universal joint 21 for pivoting the chuck 17 about a first axis 22 that extends generally longitudinal through the housing 20, and a perpendicular second axis 23. The universal joint 21 includes a yoke 25 mounted to the housing 20 to pivot relative to the housing 20 about the first axis 22 and a hub 26 supporting the chuck 17 for rotation about the chuck axis 24. A pivot 27 defines the second axis 23 and connects the yoke 25 and hub 22, thereby allowing the chuck and hub to be pivoted together relative to the yoke 25 about the second axis 23.

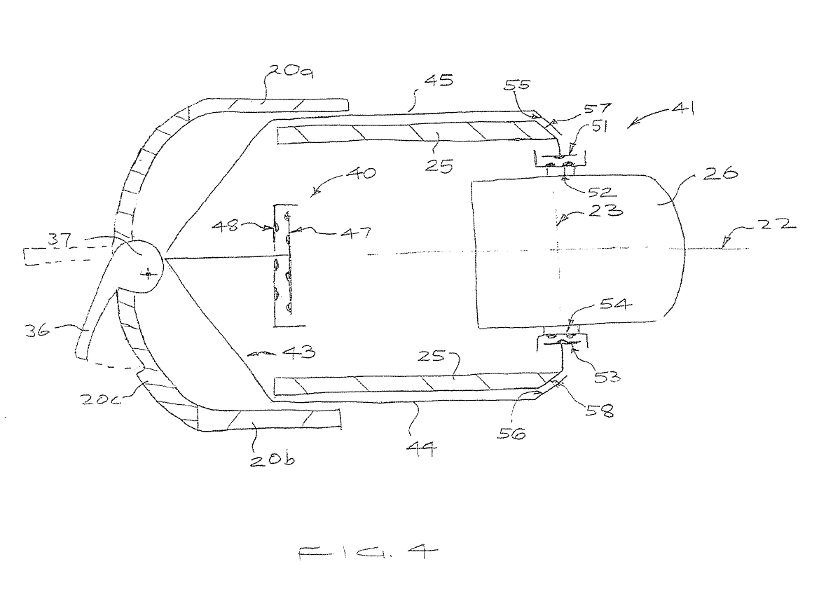

As shown in FIGS. 3-5, the yoke 25 is elongate having an inner section with a substantially cylindrical wall 28 coaxial with axis 22 and engaging complementary arcuate surfaces in the housing 20, thereby allowing the yoke 23 to pivot about the axis 22. The wall 28 also defines a cavity in which the motor 16 is received. Integral with the internal section, the yoke 25 further includes a pair of laterally opposing flanges 32, 33 which project externally beyond the forward edge 34 of the housing 20. Generally aligned longitudinally with the eccentric 31 are two coaxial pivot axles 27a, 27b which define the pivot 27 and are mounted in apertures in the flanges 32, 33. The hub 26 is disposed between the flanges 32, 33 with corresponding apertures for receiving the pivot axles.

The housing 20 may be formed of left and right shells 20a, 20b and a longitudinal end portion 20c, closing the end of the housing 20 positioned opposing the universal joint 21.

An output shaft 29 of the motor 16 is aligned coaxially and is connected to an oscillatory drive for transmitting an oscillating torque to the chuck 17. The oscillatory drive includes a coupling 30 connecting the output shaft 29 to an eccentric 31. A fork 35 engages the eccentric 31 and is rotationally fast with the chuck 17, rotating in the hub 26 about the chuck axis 24.

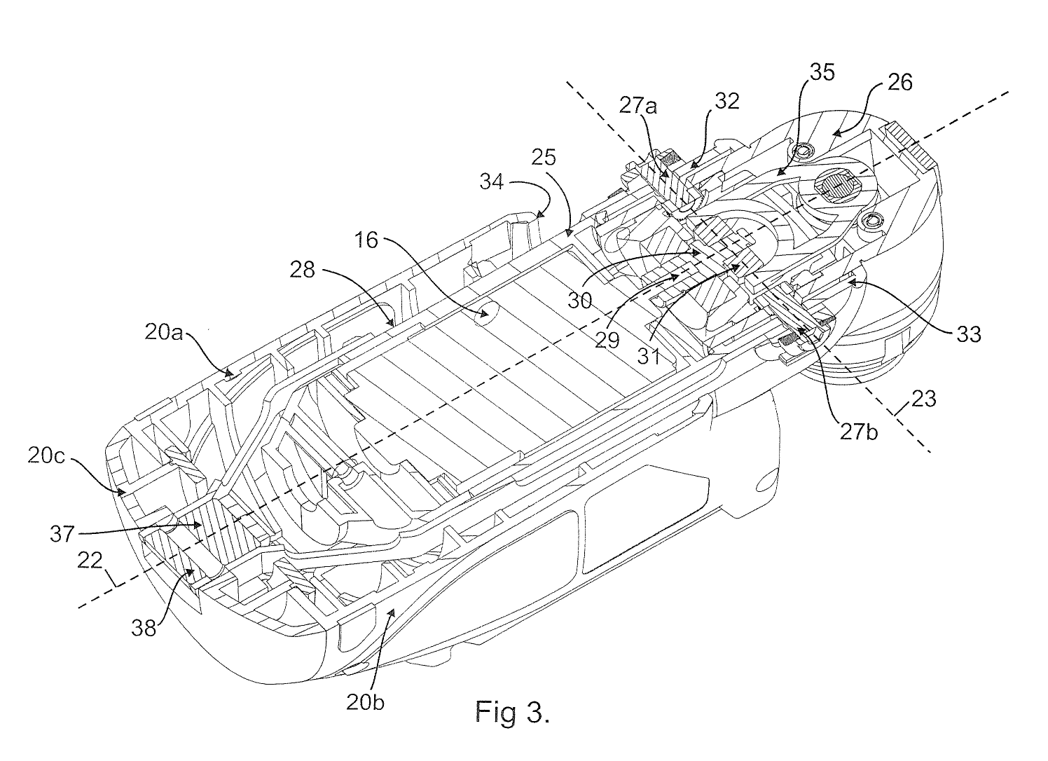

In order to use the tool it is necessary to lock the pivoting of the universal joint 21, and this is achieved by the use of two clutches. First and second clutches 40, 41 are used for locking the yoke 25 and hub 26 against turning relative to the housing 20 and yoke 25 respectively. A locking mechanism 42 operatively connects the first and second clutches 40, 41, and an actuator, in the form of a cam 37 with an integral lever 36, is manually operated to actuate the locking mechanism 42 to release both the first and second clutches 40, 41 simultaneously. The cam 37 and lever 36 are pivotally mounted to the longitudinal end portion 20c of the housing 20, generally centrally in alignment with the axis 22. The locking mechanism includes a forked slider 43 having two arms 44, 45 disposed generally symmetrically and elongated generally in the direction of the first axis 22 and which are joined at one longitudinal end, adjacent the cam 37. The cam 37 acts upon the slider 43 to move it along the first axis 22, for instance, moving the slider 43 to the (partially) released position shown in FIG. 4. With the lever 36 in its fully open position (shown in dashed outline in FIG. 4) both clutches 40, 41 are released to allow pivoting of universal joint 21. A spring (not shown) acts upon the slider 43 urging it toward the cam 37, and thus biases both clutches 40, 41 to their engaged positions, locking the universal joint 21.

The arms 44, 45 of the slider 43 are received in lengthwise slots in the yoke 25, thus the slider 43 rotates together with the yoke 25 while it may also slide relative to the yoke 25.

The first clutch 40 is of the positive type and includes a first pair of tooth sets 47, 48. The tooth set 47 of the first pair is provided on a transversely aligned ring 49 fixed to the slider 43, such that the tooth set 47 rotates with the yoke 25, but may slide axially along the yoke. The tooth set 47 is thereby moved between engaged and released positions with movement of the slider 43 along the first axis 22. The tooth set 48 of the first pair is provided on a ring (not shown) fixed to the housing 20. The engagement between the tooth sets 47, 48 thus locks the yoke 25 against pivoting relative to the housing 20.

The second clutch 41 includes a second pair of tooth sets 51, 52 and a third pair of tooth sets 53, 54 mounted generally coaxially with the second axis 23 on opposing sides of the hub 26.

The arms 44, 45 are disposed on opposing sides of the yoke 25, the arm 45 engaging the tooth set 51 of the second pair, the arm 44 engaging tooth set 53 of the third pair via a coupling mechanism which includes outer wedge surfaces 55 and 56 fixed to the arms 45 and 46 respectively. The outer wedge surfaces 55 and 56 cooperate with complementary inner wedge surfaces 57 and 58 fixed to the tooth sets 51 and 53 respectively. The inner wedge surfaces 57 and 58 are biased outwardly by springs (not shown) to engage the outer wedge surfaces 55 and 56. In this manner reciprocating movement of the slider 43 along the first axis 22 simultaneously engages and disengages the tooth sets of each of the three pairs.

The cooperating outer and inner wedge surfaces 55, 57 and 56, 58 are provided on wedges 61 and 62. The pivot axles 27a extends through an aperture in the outer wedge 62, with a head at the outer end of the pivot axles 27a abutting the outer wedges 62. Parallel guides 63 on the arms 44, 45 prevent rotation of the outer wedges 62. The inner wedges 61 are fixed to the arms 44, 45 and the pivot axles 27a extend through axially elongated slots 64 in the inner wedges 61 and arms 44, 45. The inner end of each pivot axle 27a is fixed inside the hub 26 by a fixture 68. The pairs of tooth sets 51, 52 and 53, 53 are integrally formed with the yoke 26 (on flanges 32, 33) and with the hub 26, being generally raised above opposing faces of the yoke and hub. The spring acting to displace the slider 43 this applies a tensile load to the pivot axles 27a, which in turn provides a clamping action engaging the tooth sets 51, 52 and 52, 53 of the second and third pairs, and this locking the hub 26 against rotation about axis 23 relative to the yoke 25.

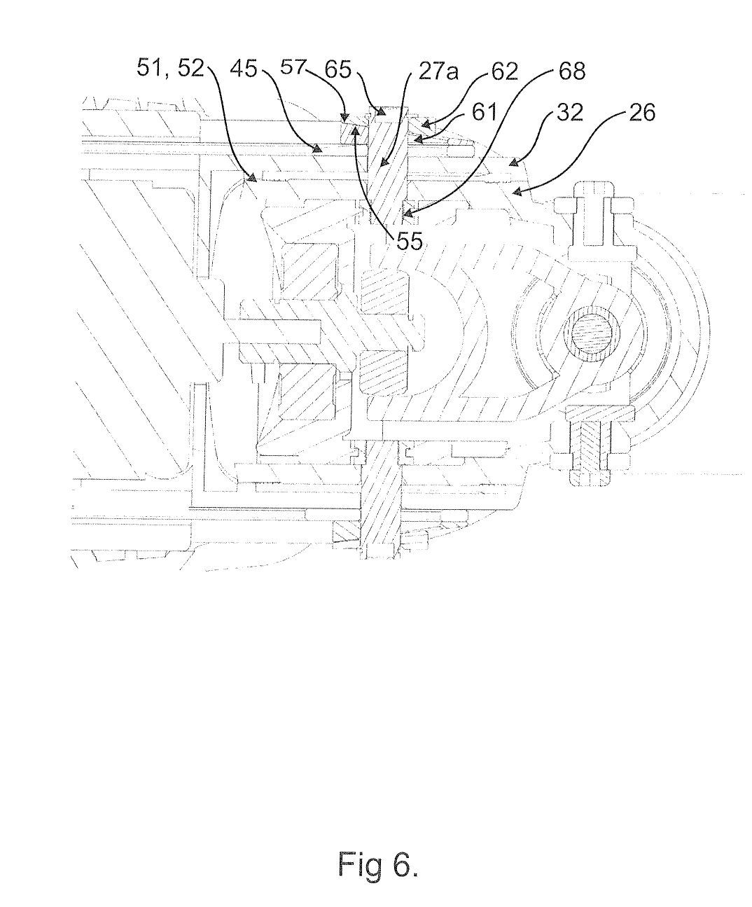

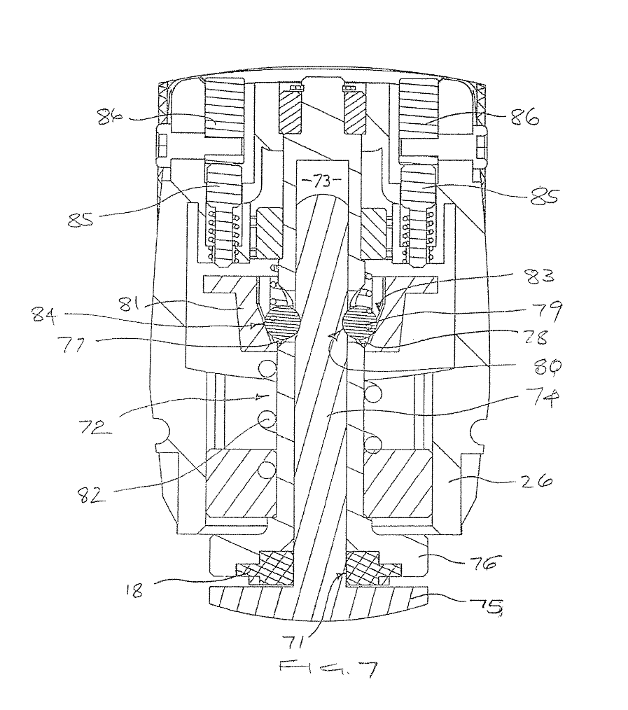

Referring to FIGS. 7 and 8, a quick release chuck 70 is illustrated for releasably holding a tool 18. It should be understood that the chuck 70 is illustrated as incorporated with the hub 26 of the above described universal joint 21 for illustrative purposes only. The present invention is in no way limited to use with such a universal joint, or to any particular type of power tool, but may be utilized in any application wherein it is desired to releasably attach a cutting tool to a power tool.

The chuck 70 is particularly suited for utilization with conventionally sized cutting tools. Conventional saw blades generally include a hole 71 formed through the flat sides thereof for receiving a fastener. The chuck 70 includes a spindle 72 with an internal longitudinal bore 73 for accepting a shank 74 inserted into the bore. In the embodiment shown, the shank 74 is formed on a fastener having a head 75, but the shank 74 may, for instance, be provided on the tool 18 itself. In the embodiment shown, the tool 18 is held between the head 75 and a flange 76 formed on a protruding end of the spindle 72. The spindle 72 also includes opposing radial bores 77, 78 in communication with longitudinal bore 73. The spindle 72 is rotationally fast with a driving member, in the form of the fork 35, by which the oscillating torque is provided. The shank 74 and bore are complementary, and may be cylindrical or multi-sided (e.g. square or hexagonal) to prevent rotation between them.

An engaging device in the form of a ball 79 is disposed in each radial bore 777, 78 and is radially movable within the bore so that at least a portion of the ball 79 extends into longitudinal bore 73 in a locking mode or position of chuck 70, as particularly illustrated in FIG. 7. In the preferred embodiment, the engaging device comprises balls 79, however, it should be understood, that engaging device can comprise any mechanical device which is capable of moving radially within radial bore so as to contact the shank 74 inserted into the longitudinal bore 73. The balls 78 are located relative to longitudinal bore 73 so as to fit into or engage a circumferential recesses 80 formed in the shank 74.

The chuck 70 also includes a spring biased outer collar 81 which is disposed about a portion of the spindle 72. The outer collar 81 is movable longitudinally relative to the spindle 72 between a released position and a locking position. The locking position of the outer collar is illustrated particularly in FIG. 7. A spring mechanism or device 82 is operably disposed between the spindle 72 and the outer collar 81 so as to bias the outer collar to its locking position. Outer collar 81 is longitudinally movable against the biasing force of spring 82.

The outer collar 81 includes an engaging surface 83, having a portion which contacts the engaging member and forces the engaging member radially inward in the locking position of collar 81 to engage the recess 80 in the shank 74. The portion of engaging surface 83 contacting the engaging member comprises a sloped portion 84, of frusto-conical form. Accordingly, as collar 81 is biased in one direction by spring 34, the sloped portion 32 forces the balls 79 radially inward. The engaging surface 83 is also configured to allow the engaging member or balls 79 to move radially outward in the released position of collar 81 thereby allowing shank to be removed from the chuck, as particularly illustrated in FIG. 8.

A release mechanism for displacing the outer collar 81 against the action of the spring 82 includes a pair of plungers 85, each mounted on an opposing side of the collar 81. A cam 86 abuts each of the plungers 85, and a lever 87 connects both cams 86 to rotate together, thereby displacing the plungers 85 and collar 81 simultaneously to release the shank 74.

Disposed on the spindle 72, either on the flange 76, or on one or more intermediate parts disposed between the spindle and the tool a mating mechanism is provided for mating the spindle to a tool. Various type of mating mechanism may be employed, such as a hexagon an array of pins, depending upon the tool to be used.

Aspects of the present invention have been described by way of example only and it should be appreciated that modifications and additions may be made thereto without departing from the scope thereof.

1. A hand-held power tool comprising:
a housing;
a motor mounted in the housing;
a two-axis universal joint mounted to the housing, the universal joint supporting a rotary chuck; and
a drive connected between the motor and the chuck, for transmitting torque to the chuck.

2. The power tool of claim 1, wherein the drive is an oscillatory drive for transmitting an oscillating torque to the chuck.

3. The power tool of claim 2, wherein the universal joint includes:
a yoke mounted to the housing and pivoting relative to the housing about a first axis;
a hub supporting the chuck for rotation about a chuck axis;
a pivot defining a second axis substantially perpendicular to the first axis, the pivot connecting the yoke and the hub, wherein the chuck and the hub may be pivoted together, relative to the yoke, about the second axis;
first and second clutches for locking the yoke and hub against turning relative to the housing and the yoke, respectively;
a locking mechanism operatively connecting the first and second clutches; and
an actuator that is manually operated to actuate the locking mechanism to release both the first and second clutches simultaneously.

4. The power tool of claim 3, wherein the first and second clutches are positive or dog type clutches.

5. The power tool of claim 4, wherein the motor is a rotary motor mounted to rotate with the yoke.

6. The power tool of claim 4, wherein the yoke includes a cavity in which the rotary motor is received.

7. The power tool of claim 3, wherein the rotary motor has a drive shaft which rotates about the first axis and the oscillatory drive includes an eccentric coupled to the drive shaft.

8. The power tool of claim 7, wherein the chuck axis of the chuck is aligned substantially perpendicular to the second axis, and the oscillatory drive includes a fork that engages the eccentric, the fork being rotationally fixed with respect to the chuck.

9. The power tool of claim 4,
wherein
the locking mechanism includes a slider rotating together with the yoke about the first axis, the slider sliding relative to the yoke, the slider being operatively connected to the actuator such that operation of the actuator displaces the slider along the first axis,
the first clutch includes a first pair of tooth sets,
the second clutch includes second and third pairs of tooth sets, and further comprising
a coupling mechanism that, during movement of the slider along the first axis to a locking position, displaces a first tooth set of the first pair of tooth sets to engage a second tooth set of the first pair of tooth sets, and that simultaneously urges together first and second tooth sets of the second and third pairs of tooth sets.

10. The power tool of claim 9, wherein the locking mechanism further includes:
a rotary cam operatively coupled to the actuator; and
a biasing spring urging the slider to engage the cam, the cam acting upon the slider to move the slider along the first axis against a force applied by the biasing spring.

11. The power tool of claim 10, wherein
the slider includes two arms elongated generally along the first axis and disposed on opposing sides of the yoke, both of the arms acting to displace the first of the tooth sets of the first pair of tooth sets, and
the coupling mechanism includes a respective wedge fixed to each of the arms, a first of the wedges engaging the first tooth set of the second pair of tooth sets and a second of the wedges engaging the first tooth set of the third pair of tooth sets.

12. The power tool of claim 11, wherein no hand grip, or trigger operated by a user holding a hand grip, is provided on the housing.

13. The power tool of claim 12, wherein the power tool further includes a handle module detachably mountable to the housing, the handle module including a hand grip, a trigger, and a battery pack.

14. The power tool of claim 1 further including a quick release chuck for releasably engaging a shank, the quick release chuck comprising:
a spindle having an internal longitudinal bore for accepting a shank inserted into the internal longitudinal bore;
at least one radial bore in the spindle and extending into the internal longitudinal bore;
an engaging device disposed in the radial bore, the engaging device being radially movable within the radial bore so that at least a portion of the engaging device extends radially into the internal longitudinal bore in a locking mode of the chuck;
a spring biased outer collar disposed about at least a portion of the spindle, the outer collar being movable longitudinally relative to the spindle, between a released position and a locking position, the outer collar comprising an engaging surface having a portion contacting the engaging device and forcing the engaging device radially inward in the locking position to engage a recess in the shank inserted into the internal longitudinal bore, the engaging surface allowing the engaging device to move radially outward in the released position to release a saw blade from the quick release chuck; and
a spring member operably disposed relative to the outer collar and the spindle and biasing the collard toward the locking position.

15. The power tool of claim 14, further comprising a mating mechanism for mating the spindle to a driving member of the power tool.

16. The power tool of claim 14, wherein the mating mechanism comprises an array of pins.

17. The power tool of claim 14, wherein the spindle is rotationally fixed with respect to a driving member of the power tool.

18. The power tool of claim 14, wherein the at least one radial bore comprises two radially oppositely disposed radial bores and engaging members such that the engaging members engage opposite sides of the shank in the internal longitudinal bore.

19. The power tool of claim 18, wherein each engaging member comprises a ball.

20. The power tool of claim 19, wherein the engaging surface further comprises a tapered section contacting the engaging device in the locking position and an adjacent section which includes a recess area for the ball in the released position of the outer collar.

21. The power tool of claim 14 further comprising
a pair of plungers for abutting opposing sides of the collar,
a pair of cams, a respective cam abutting each of the plungers, and
a lever connecting the cams for displacing the plungers simultaneously to release the shank.

22. A quick release chuck for releasably engaging a shank, the quick release chuck comprising:
a spindle having an internal longitudinal bore for accepting a shank inserted into the internal longitudinal bore;
at least one radial bore in the spindle and extending into the internal longitudinal bore;
an engaging device disposed in the radial bore, the engaging device being radially movable within the radial bore so that at least a portion of the engaging device extends radially into the internal longitudinal bore in a locking mode of the quick release chuck;
a spring biased outer collar disposed about at least a portion of the spindle, the outer collar being movable longitudinally relative to the spindle, between a released position and a locking position, the outer collar comprising an engaging surface having a portion contacting the engaging device and forcing the engaging device radially inward in the locking position to engage a recess defined in the shank inserted into the internal longitudinal bore, the engaging surface allowing the engaging device to move radially outward in the released position to release a saw blade from the quick release chuck; and
a spring member operably disposed relative to the outer collar and the spindle and biasing the collar toward the locking position.

23. The chuck of claim 22, further comprising a mating mechanism for mating the spindle to a driving member of a power tool.

24. The chuck of claim 22, wherein the mating mechanism comprises an array of pins.

25. The chuck of claim 22, wherein the spindle is rotationally fixed with respect to a driving member of a power tool.

26. The chuck of claim 22, wherein the at least one radial bore comprises two radially oppositely disposed radial bores and engaging members such that the engaging members engage opposite sides of the shank in the internal longitudinal bore.

27. The chuck of claim 26, wherein each engaging member comprises a ball.

28. The chuck of claim 27, wherein the engaging surface further comprises a tapered section contacting the engaging device in the locking position and an adjacent section which includes a recess area for the ball in the released position of the outer collar.

29. The chuck of claim 22 further comprising
a pair of plungers for abutting opposing sides of the collar,
a pair of cams, a respective cam abutting each of the plungers, and
a lever connecting the cams for displacing the plungers simultaneously to release the shank.
